(19) United States
(12) Patent Application Publication
(10) Pub. No.: US 2021/0362402 A1
(43) Pub. Date: Nov. 25, 2021

(54) DETECTING THREE-DIMENSIONAL (3D) PART LIFT AND DRAG

(71) Applicant: Hewlett-Packard Development Company, L.P., Spring, TX (US)

(72) Inventors: Sunil Kothari, Palo Alto, CA (US); Tod Heiles, Sumner, WA (US); Luke Bockman, Vancouver, WA (US); Gary J. Dispoto, Palo Alto, CA (US); Md Abdullah Al Hafiz Khan, Palo Alto, CA (US)

(73) Assignee: Hewlett-Packard Development Company, L.P., Spring, TX (US)

(21) Appl. No.: 17/256,683

(22) PCT Filed: Jan. 23, 2019
(86) PCT No.: PCT/US2019/014723

§ 371 Date: Dec. 29, 2020

(51) Int. Cl. B29C 64/153; B29C 64/218; B29C 64/273; B29C 64/393; B29C 64/209; B33Y 10/00; B33Y 30/00; B33Y 50/02

(52) U.S. Cl. CPC B29C 64/153; B29C 64/218; B29C 64/273; B33Y 50/02; B29C 64/209; B33Y 10/00; B33Y 30/00; B29C 64/393

(57) ABSTRACT

A system for detecting three-dimensional (3D) part drag includes a layer deposition device, and a sensor to detect a change in a process parameter associated with the operation of the layer deposition device within a 3D part build region of a 3D printing device on which a part is built, the change in a process parameter indicating part drag.

### BACKGROUND

Three-dimensional (3D) printing is dramatically changing the manufacturing landscape. Via 3D printing, articles and components may be manufactured without the resources of a factory or other large-scale production facility. Additive manufacturing systems produce three-dimensional (3D) objects by building up layers of material and combining those layers using adhesives, heat, chemical reactions, and other coupling processes. Some additive manufacturing systems may be referred to as “3D printing devices.” The additive manufacturing systems make it possible to convert a computer aided design (CAD) model or other digital representation of an object into a physical object. Digital data is processed into slices each defining that part of a layer or layers of build material to be formed into the object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is an elevational, side-view block diagram of an additive manufacturing device, according to an example of the principles described herein.

FIG. 2 is an elevational, side-view block diagram of an additive manufacturing device, according to an example of the principles described herein.

FIG. 3 is a block diagram of an image of a build region including a number of parts being printed, according to an example of the principles described herein.

FIG. 4 is a block diagram of an image of a build region including a number of parts being printed and with a protruding portion of one of the parts, according to an example of the principles described herein.

FIG. 5 is a block diagram of an image of a build region including a number of parts being printed and with one of the parts being subjected to a drag instance, according to an example of the principles described herein.

FIG. 6 is a flowchart showing a method of detecting three-dimensional (3D) part lift and drag, according to an example of the principles described herein.

FIG. 7 is a flowchart showing a method of detecting 3D part lift and drag, according to an example of the principles described herein.

FIG. 8 is a flowchart showing a method of detecting 3D part lift and drag, according to an example of the principles described herein.

FIG. 9 is a flowchart showing a method of detecting 3D part lift and drag, according to an example of the principles described herein.

FIG. 10 is a flowchart showing a method of detecting 3D part lift and drag, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Examples provided herein include apparatuses, processes, and methods for generating three-dimensional objects. Apparatuses for generating three-dimensional objects may be referred to as additive manufacturing apparatuses. Example apparatuses described herein may correspond to three-dimensional printing systems, which may also be referred to as three-dimensional printers. In an example additive manufacturing process, a layer of build material may be formed in a build area, a fusing agent may be selectively distributed on the layer of build material, and energy may be temporarily applied to the layer of build material. As used herein, a build layer may refer to a layer of build material formed in a build area upon which agent may be distributed and/or energy may be applied.

Additional layers may be formed and the operations described above may be performed for each layer to thereby generate a three-dimensional object. Sequentially layering and fusing portions of layers of build material on top of previous layers may facilitate generation of the three-dimensional object. The layer-by-layer formation of a three-dimensional object may be referred to as a layer-wise additive manufacturing process.

In examples described herein, a build material may include a powder-based build material, where powder-based build material may comprise wet and/or dry powder-based materials, particulate materials, and/or granular materials. In some examples, the build material may be a weak light absorbing polymer. In some examples, the build material may be a thermoplastic. Furthermore, as described herein, agent may comprise fluids that may facilitate fusing of build material when energy is applied. In some examples, agent may be referred to as coalescing or fusing agent. In some examples, agent may be a light absorbing liquid, an infrared or near infrared absorbing liquid, such as a pigment colorant. In some examples at least two types of agent may be selectively distributed on a build layer. In some examples at least one agent may inhibit fusing of build material when energy is applied.

Example apparatuses may comprise an agent distributor. In some examples, an agent distributor may comprise at least one fluid ejection device. A fluid ejection device may comprise at least one printhead (e.g., a thermal ejection based printhead, a piezoelectric ejection based printhead, etc.). An agent distributor may be coupled to a scanning carriage, and the scanning carriage may move along a scanning axis over the build area. In one example, printheads suitable for implementation in commercially available inkjet printing devices may be implemented as an agent distributor. In other examples, an agent distributor may comprise other types of fluid ejection devices that selectively eject small volumes of fluid.

In some examples, an agent distributor may comprise at least one fluid ejection device that comprises a plurality of fluid ejection dies arranged generally end-to-end along a width of the agent distributor. In some examples, the at least one fluid ejection device may comprise a plurality of printheads arranged generally end-to-end along a width of the agent distributor. In such examples, a width of the agent distributor may correspond to a dimension of a build area. For example, a width of the agent distributor may correspond to a width of a build area. An agent distributor may selectively distribute agent on a build layer in the build area concurrent with movement of the scanning carriage over the build area. In some example apparatuses, the agent distributor may comprise nozzles including nozzle orifices through which agent may be selectively ejected. In such examples, the agent distributor may comprise a nozzle surface in which a plurality of nozzle orifices may be formed.

In some examples, apparatuses may comprise a build material distributor to distribute build material in the build area. A build material distributor may comprise, for example, a wiper blade, a roller, and/or a spray mechanism. In some examples, a build material distributor may be coupled to a scanning carriage. In these examples, the build material distributor may form build material in the build area as the scanning carriage moves over the build area along the scanning axis to thereby form a build layer of build material in the build area.

When the surface temperature of the initial layers of a part in the build region of the additive manufacturing device drops below a crystallization onset temperature of approximately 153° C. long enough for crystallization to initiate, the part will begin to shrink and curl as it crystallizes. The part may initially curl on the perimeter portions of the part due to greater cooling to the surrounding build material such as a powder. As the part curls, the part will lift off of the bed surface and become elevated relative to the surrounding build material. The elevated part may then collide with translating devices within the additive manufacturing device such as a spreader roller, hopper, an energy emitting device, and/or a printing agent dispenser initially and may rock back and forth with each pass or may by dragged across the surface of the build region and the build material deposited thereon. The degree of crystallization and part geometry may determine whether the part rocks or is dragged. If part lifting is allowed to continue, the issue of part lifting may, in some instances, cure itself as more fusing agent is applied and the part gains temperature. However, in some instances, the part lifting issue may worsen to the point where it crashes with the translatable elements within the additive manufacturing device. Thus, part lifting and possible part drag is a symptom of out of balance conditions in the build chamber.

The part lifting and possible dragging may occur due to an incorrect calibration in an imaging device such as a forward-looking infrared (FLIR) camera. If the imaging device is improperly calibrated and is reporting temperatures higher than the actual temperature, the additive manufacturing device will not apply an adequate amount of energy to the build material which may result in an actual build region temperature lower than a target temperature. Cold build material temperatures may cause the perimeter of the parts to cool too quickly and cause crystallization, shrink, and curl.

The part lifting and possible dragging may also occur due to a lack of build material. If an inadequate dose of build material is delivered to the build region, the temperature build material in a control region (i.e., region of interest) may cause the proportional-integral derivative (PID) control of the warming lamp power to respond to the change in the build region. This response may cause the warming lamp power to be lowered which may result in the temperature of the build material dropping below the target temperature in some areas of the build region. A lack of build material ruins the build.

The part lifting and possible dragging may also occur due to too much build material. As dose mass of the build material increases beyond a specification of, for example, approximately 7.0 g+/−0.5, more energy may be extracted from the surfaces of the part into the surrounding build material including the dosed mass as it is being spread. This may cause the part surface temperate to drop and may lead to curling. The incoming build material dose acts as a quenching process. If too much heat is removed in the spreading process, the parts will curl and drag at those layers of the build material.

A dose plate heater may also cause parts to curl and drag if the dose plate heater is not providing a correct and uniform temperature of the incoming build material dose. An incoming build material dose that is correct in mass and temperature produces a success build. If the dose mass varies across the build plate, it may create hot and cold swaths on the build region. If the dose temperature varies across the dose plate (i.e. colder in the front and back), cold zones may be created that might cause the parts to curl.

Printing agent dispenser air leaks may also be a cause of part lifting and possible dragging of the parts. The printing agent dispenser includes an internal cooling system. If the seals on the bottom of the printing agent dispenser are leaking and blowing on the build area, the increased convection this leaking causes may cause parts to curl and drag. This may be detected as a cold streak on FLIR camera plots. Further, the build region may include four resistive heaters on the perimeter of the build region. These heaters assist in reducing the thermal roll off in the perimeter of the build area, particularly along the front and rear of the build region. If the resistive heaters are not functioning correctly, the resistive heaters may increase the thermal roll off and result in parts curling and dragging along the front and rear of the build region.

Further, energy emitting device (i.e., a fusing module) may be contaminated with build material along a quartz glass pane located on the bottom of the energy emitting device. This quartz glass pane may become excessively contaminated with burnt on build material. The burnt build material blocks electromagnetic energy from being transmitted from the lamp filament of the energy emitting device to the build material. The reduced energy transfer to the build material causes lower build material temperatures and increased probability of crystallization, curling, and dragging.

Still further, internal energy emitting device contamination may also be a cause of part lifting and possible dragging of the parts. The clean air management system of an additive manufacturing device may not always provide clean cooling air to the energy emitting device. If there is airborne build material in the cooling air, it may burn on the reflectors and lamps of the energy emitting device and may reduce energy transfer into the build material in localized regions. The cooler regions then become potential regions for part curling and dragging. Further, if all four lamps of the energy emitting device are not functioning correctly, the reduced energy emissions from the energy emitting device may result in the additive manufacturing system being out of balance and part and build material temperatures not reaching the process targets.

Further, as the layers of build material are deposited in the build area, the fusing agent is selectively distributed on the layers of build material, and energy applied to the layer of build material, the parts may experience fluctuations in temperature, humidity, and other environmental conditions within and without the build area of the 3D printing device. These fluctuations in the environmental conditions may cause defects during the building of the parts. Further, defects within the part may occur as the 3D printing device operates or operates in a deviating manner from its intended mode of operation or in a defective manner. These defects may include a lifting of portions of the part or, stated in another manner, a protrusion of portions of the parts above surrounding build material.

These protrusions may be below a threshold or insignificant enough to not be of a concern to where this type of defect may not significantly affect the look and feel or functionality of the part. Further, the protrusions may not, at these insignificant levels cause the remainder of the 3D printing operations to be affected. However, in many instances, the protrusions may be above the threshold or may be significant enough to cause damage to the part being built and/or cause damage to a number of devices within the 3D printing device. For example, the protrusions in the part may be so severe that the protrusion may come into contact with moveable elements within the 3D printing device such as, for example, a printing carriage including a printing fluid deposition device that is used to deposit the printing fluid onto a layer of build material, a build material deposition device used to deposit the build material within the build region, a build material spreader used to spread the deposited build material in a level plane on the on the build region, a heating element used to heat the build material in preparation for or in order to fuse or sinter the build material, a fusing or sintering device used to fuse or sinter the deposited build material, and combinations thereof.

Because these devices translate across and/or above the surface of the build region, it is possible that the protruding portions of the part may come into contact with the translating devices. This may cause damage to the translating devices as the protrusion of the part comes into contact with the translating devices. For example, dragging of the part may cause clogging of nozzles of a printing fluid deposition device. Further, the contact between the protrusion of the part and the translating devices may cause the part to be pulled or dragged across the build region damaging the protruding part, other parts being built during the same batch, and combinations thereof. Lift or the formation of the protrusions in the part is a precursor to the dragging of the part. Thus, for the reasons described above, it may prove beneficial for the 3D printing device to be able to autonomously detect when a lifting or protrusion of the part occurs, and take remedial action such as discontinuing the build of that part, restarting the build of that part, removing the protrusion from the part, and combinations thereof.

Examples described herein provide a system for detecting three-dimensional (3D) part drag that includes a layer deposition device, and a sensor to detect a change in a process parameter associated with the operation of the layer deposition device within a 3D part build region of a 3D printing device on which a part is built, the change in a process parameter indicating part drag.

The layer deposition device may include an energy emitting device, a build material spreader roller, or combinations thereof. The layer deposition device may include a build material spreader roller, where the sensor detects a change in a slew torque of the build material spreader roller, and the change in the slew torque of the build material spreader roller indicates part drag. The layer deposition device may include a build material warming lamp where the sensor detects a change in a temperature-related parameter of the build material, and the change in the temperature of the build material indicates part drag. The temperature-related parameter of the build material comprises a pulse-width modulation used to control the activation of the build material warming lamp, the pulse-width modulation defining how the build material warming lamp reacts to a change in temperature of the build material.

Examples described herein also provide a method of detecting three-dimensional (3D) part drag including activating a layer deposition device at a 3D part build region of a 3D printing device on which a part is built, and with a sensor, detecting a change in a process parameter associated with the operation of the layer deposition device, the change in a process parameter indicating part drag.

The layer deposition device may include a build material spreader roller, and the method may include, with the sensor, detecting a change in a slew torque of the build material spreader roller, the change in the slew torque of the build material spreader roller indicating part drag. The layer deposition device may include a build material warming lamp, and the method may include, with the sensor, detecting a change in a temperature-related parameter of the build material, the change in the temperature-related parameter of the build material indicating part drag.

The method may include, in response to a determination that the sensor detects a change in a process parameter, taking a remedial action to correct the part drag. The remedial action comprises, with an ablation laser, removing protrusions from the part along an x,y plane of the build region, tagging the part as a confirmed draggable part, abandoning the build of a layer of the part, abandoning the build of the part, initiating a new build of the part, adjusting a layer thickness of a deposited layer, adjusting a printing parameter of an agent deposited on the build region, adjusting torque output by the build material spreader roller, or combinations thereof. Detecting a change in a process parameter associated with the operation of the layer deposition device comprises observing violations of an upper control limit (UCL) and a lower control limit (LCL).

Examples described herein also provide a non-transitory computer readable medium including computer usable program code embodied therewith. The computer usable program code may, when executed by a processor, activate a layer deposition device at a 3D part build region of a 3D printing device on which a part is built, detect a change in a process parameter associated with the operation of the layer deposition device, the change in a process parameter indicating part drag, and taking a remedial action to correct the part drag.

The process parameter includes a warming parameter of a build material warming lamp, a slew torque of the build material spreader roller, or combinations thereof. The layer deposition device may include a build material spreader roller; and the computer readable medium may include computer usable program code to, when executed by the processor, detect, with a sensor, a change in a slew torque of the build material spreader roller, the change in the slew torque of the build material spreader roller indicating part drag. The layer deposition device may include a build material warming lamp, and the computer readable medium may include computer usable program code to, when executed by the processor, detect a change in a temperature of a build material, the change in the temperature of the build material indicating part drag.

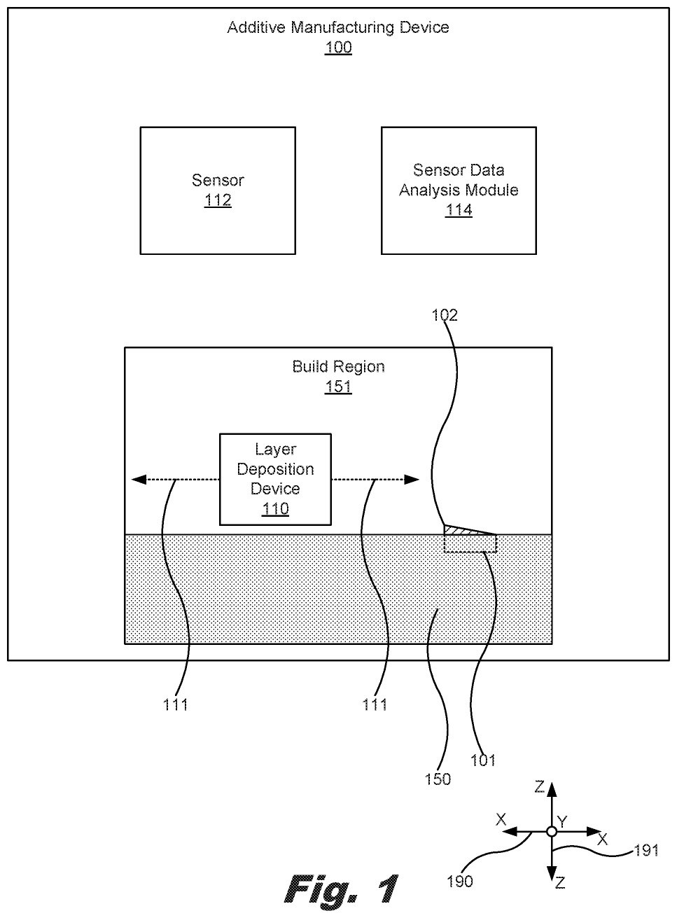

Turning now to the figures, FIG. 1 is an elevational, side-view block diagram of an additive manufacturing device (100), according to an example of the principles described herein. The additive manufacturing device (100) may be any device that produces three-dimensional (3D) objects by building up layers of material and combining those layers using adhesives, heat, chemical reactions, and other coupling processes, and may include, for example, a 3D printing device. The additive manufacturing device (100) may form or include a process parameter monitoring system for detecting 3D part lift and drag that may occur within the additive manufacturing device (100). Throughout the examples described herein, the lifting of a part (i.e., the formation of protrusions on the part above a surface of the build material abnormally) is the cause of dragging of the part, and dragging of the part within the build region (151) of the 3D printing device is a failure event that is sought herein to be reduced or eliminated.

The additive manufacturing device (100) may include a build region (151) at which the parts are built. The part (101) depicted in FIG. 1 has been formed through successive layers of build material (150) being placed on top of one another, and a portion of the part (101) formed exists in lower layers of the build material. As the part (101) is built, conditions may exist that create a protruding portion (102) of the part (101). The protruding portion (102) extends above an x,y plane of the build material (150) when this occurs, and it is the lifting and possible dragging that the systems and methods described herein are seeking to correct.

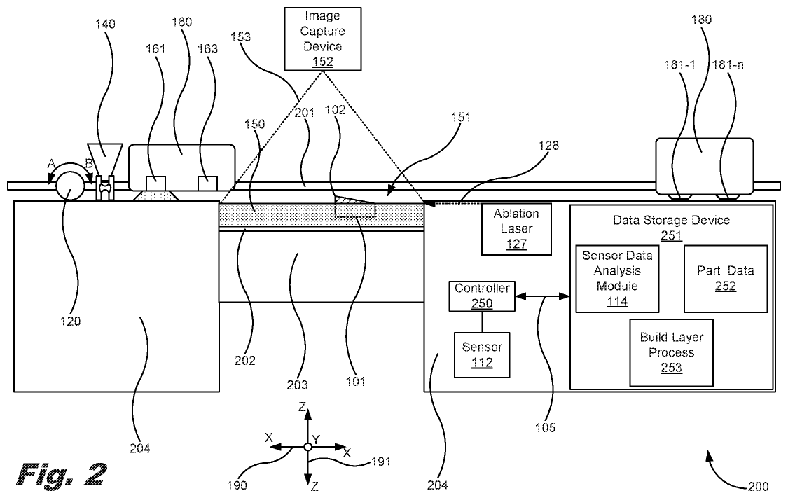

The additive manufacturing device (100) may also include at least one layer deposition device (110) that is used to form layers of deposited build material. These layer deposition devices (110) may include, for example, a material spreader (FIG. 2, 120), a hopper (FIG. 2, 140), an energy emitting device (FIG. 2, 160), a printing agent dispenser (FIG. 2, 180), a build platform (FIG. 2, 202), a build platform base (FIG. 2, 203) to move and actuate in a manner that produces the part (101) based on part data (FIG. 2, 252) stored in a data storage device (FIG. 2, 251) of the additive manufacturing device (100, 200), other layer deposition devices (110), and combinations thereof. Although one layer deposition device (110) is depicted in FIG. 1, any number of layer deposition devices (110) may be included within the additive manufacturing device (100) such as the layer deposition devices (120, 140, 160, 180) depicted in FIG. 2.

The additive manufacturing device (100) may also include at least one sensor (112) used to sense a process parameter of the layer deposition device (110). In FIG. 1, the sensor (112) is depicted as being a separate element with respect to the layer deposition device (110). However, in another example, the sensor (112) may be integrated into the layer deposition device (110). The sensor (112) may sense any process parameter of the additive manufacturing device (100) or any layer deposition device (110) included therein. For example, process parameters may be any instruction to the additive manufacturing device (100) that may be changed or adjusted, and may include, for example, fusing lamp power levels, fusing lamp scan speeds, warming lamp power levels, warming lamp scan speeds, a pulse-width modulation used to control the activation of the build material warming lamp, powder temperatures, humidity levels, powder dose volumes, spreader roller rotation velocities, spreader roller transverse velocities, a slew torque of the spreader roller, fusing agent density levels, cooling agent density levels, build material melting points, build material crystallization temperatures, build material conductivity, build material thermal mass values, build material thermal properties, build material densities, build material flowability, build material friction properties, build material mechanical properties, part model used, a percentage of the volume of the part assigned to a core of the part model used, a percentage of the volume of the part assigned to a mantle of the part model used, a percentage of the volume of the part assigned to a shell of the part model used, part post processing methods used, percentage of part expansion of an original geometry of the part, percentage of part dilation of the original geometry of the part, other process parameters, and combinations thereof. In the examples described herein the slew torque of a spreader roller (FIG. 2, 120) and the pulse-width modulation used to control the activation of the energy emitting device (FIG. 2, 160) are described. However, any layer deposition device (FIG. 2, 120, 140, 160, 180) and its associated sensed process parameters as provided by the sensor (112) may be used to determine the presence of a protrusion (102) in the part (101) and/or an instance of a part drag.

The build region (151) is heated throughout the build process of the part (101). Further, where the part is formed, heat is concentrated through the application of a printing agent such as a fusing or sintering agent that causes the build material (150) to fuse or sinter together in layers. The sensor (112) detects a change in a process parameter associated with the operation of the layer deposition device (110) within the build region (151) of the additive manufacturing device (100) on which a part (101) is built. The sensed change in a process parameter may be used to indicate or detect the lift instance as physically manifested as a protrusion (102) in the part (101) and/or a drag instance of the part (101) as physically manifested as a disruption in the build material (150) as the part (101) is dragged through the build material (150).

A sensor data analysis module (114) may be used to analyze the data obtained by the sensor(s) (112) and use that data to determine whether a lift instance and/or a drag instance is present in the build region (151). The sensor data analysis module (114) may determine whether the data obtained from the sensor (112) contains a deviation or some other anomaly that is indicative of the lift instance and/or a drag instance. In an example where the layer deposition device (110) is a spreader roller (FIG. 2, 120) and the sensor (112) is able to sense a slew torque of the spreader roller (FIG. 2, 120), the sensor data analysis module (114) may analyze the slew torque data obtained by the sensor (112) to determine if the slew torque has changed as the spreader roller (FIG. 2, 120) traverses the build region (151) and does or does not come into contact with the protrusion (102) of the part (101) and/or drags the part (101) across the build region (151). In this example, the sensor (112) may be a speedometer (velocimeter) that detect the speed of rotation of the spreader roller (FIG. 2, 120), a force sensor used to sense the force applied by spreader roller (FIG. 2, 120) as it spreads the build material (150), a rotary encoder that detects and converts the angular position or motion of the spreader roller (FIG. 2, 120), any other sensor that may sense the torque applied by the spreader roller (FIG. 2, 120), and combinations thereof.

In an example where the layer deposition device (110) is an energy emitting device (FIG. 2, 160), the sensor (112) may be able to identify a pulse-width modulation used to control the energy emitting device (FIG. 2, 160) as it warms the build material (150) and fuses or sinters the build material (150) to form the part (101). The sensor data analysis module (114) in this example may analyze the detected pulse-width modulation and how the pulse-width modulation has changed as the energy emitting device (FIG. 2, 160) traverses the build region (151) and does or does not come into contact with the protrusion (102) of the part (101) and/or drags the part (101) across the build region (151). In this example, the sensor (112) may include a sensor to detect the manner in which the energy emitting device (FIG. 2, 160) reacts to a change in temperature of the in the build region (151) and surrounding areas in order to supply enough energy to the build material (150) to cause portions of the build material (150) to fuse or sinter to form a layer of the part (101). In this example, a second temperature sensor may be used by the energy emitting device (FIG. 2, 160) to detect the temperatures of the build material (150) and parts (101) within the build region (151). Although these two examples of detection of slew torque and pulse-width modulation using the sensor (112) are described herein, any number of sensors (112) may be used to detect any number of process parameters of the layer deposition devices (110) to detect the lift instance as physically manifested as a protrusion (102) in the part (101) and/or a drag instance of the part (101) as physically manifested as a disruption in the build material (150) as the part (101) is dragged through the build material (150).

In response to a determination that the sensor (112) detects the presence of a lift instance or a drag instance vis-à-vis the detection of a change in the process parameters, the additive manufacturing device (100) may take a number of remedial actions to correct the lift instance or the drag instance. The remedial measures may include, for example, adjusting a layer thickness of a deposited layer of the build material (150), adjusting an amount of printing agent deposited on the build region (151) by a printing agent dispenser (FIG. 2, 180), adjusting a torque output by a material spreader (FIG. 2, 120), activating an electromagnetic wave source such as an energy emitting device (FIG. 2, 160), removing protrusions from the along the x,y plane with an ablation laser (FIG. 2, 127), heating the build material (150) with the ablation laser (FIG. 2, 127), abandoning the build of a layer of the part (101), abandoning the build of the part (101) altogether, initiating a new build of the part (101), adjusting the printing parameters of a print agent, correcting operation of a translatable device (120, 140, 160, 180), replacing the translatable device (120, 140, 160, 180), presenting a warning of a drag event to a user, tagging the part (101) as a confirmed draggable part, and combinations thereof.

The additive manufacturing device (100) may also include at least one image capture device (152) to capture an image of the build region (151). The field of view of the image capture device (152) is indicated by lines 153. The image capture device (152) may capture images of the build region (151) in any of a number of wavelengths including ultraviolet (UV) wavelengths, visible wavelengths, infrared (IR) wavelengths, and combinations thereof. In other words, the image capture device (152) may capture images in a visible electromagnetic spectrum, an infrared electromagnetic spectrum, an ultraviolet electromagnetic spectrum, and combinations thereof. Further, the image capture device (152) may be a red-green-blue (RGB) camera, a monochromatic camera, a spectral camera, or combinations thereof.

In one example, a plurality of image capture devices (152) may be included in the additive manufacturing device (100). In one example, the image capture device (152) may be an infrared (IR) camera such as a forward-looking infrared (FLIR) camera to capture thermal images of the build region (151).

FIG. 2 is an elevational block diagram of an additive manufacturing device (200), according to an example of the principles described herein. The additive manufacturing device (200) of FIG. 2 includes those elements described above in connection with the additive manufacturing device (100) of FIG. 1 and includes additional elements. These elements will now be described in more detail. The additive manufacturing device (200) may be implemented in or in connection with an electronic device. Examples of electronic devices include desktop computers, laptop computers, personal digital assistants (PDAs), mobile devices, smartphones, gaming systems, and tablets, among other electronic devices. The additive manufacturing device (200) may be implemented as a standalone device that includes the logic and circuitry to perform the methods described herein.

The additive manufacturing device (200) may be utilized in any data processing scenario including, stand-alone hardware, mobile applications, through a computing network, or combinations thereof. Further, the additive manufacturing device (200) may be used in a computing network, a public cloud network, a private cloud network, a hybrid cloud network, other forms of networks, or combinations thereof. In one example, the methods provided by the additive manufacturing device (200) are provided as a service over a network by, for example, a third party. In this example, the service may include, for example, the following: a Software as a Service (SaaS) hosting a number of applications; a Platform as a Service (PaaS) hosting a computing platform including, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the additive manufacturing device (200) are executed by a local administrator.

To achieve its desired functionality, the additive manufacturing device (200) includes various hardware components. Among these hardware components may be a controller (250) and a data storage device (251). These hardware components may be interconnected through the use of a number of busses and/or network connections such as via a bus (105).

The controller (250) may include the hardware architecture to retrieve executable code from the data storage device (251) and execute the executable code. The executable code may, when executed by the controller (250), cause the controller (250) to implement at least the functionality of operating the various elements of the additive manufacturing device (200). Further, the executable code may, when executed by the controller (250), activate a layer deposition device (110, 120, 140, 160, 180) at a build region (151) of an additive manufacturing device (100, 200) on which a part (101) is built, and with a sensor (112), detect a change in a process parameter associated with the operation of the layer deposition device (110, 120, 140, 160, 180) where the change in a process parameter indicates a part lift instance and/or a part drag instance.

Further, the executable code may, when executed by the controller (250), where the layer deposition device (110, 120, 140, 160, 180) includes a build material spreader roller (120), detecting a change in a slew torque of the build material spreader roller (120) with the sensor (112) where the change in the slew torque of the build material spreader roller (120) indicates a part lift instance and/or a part drag instance. Still further, the executable code may, when executed by the controller (250), where the layer deposition device (110, 120, 140, 160, 180) includes an energy emitting device (160), detects a change in a temperature of the build material (150) where the change in the temperature of the build material (150) indicates a part lift instance and/or a part drag instance.

Further, the executable code may, when executed by the controller (250), take a remedial action to correct the part lift instance and/or a part drag instance in response to a determination that the sensor (112) detects a change in a process parameter. Again, the remedial measures may include, for example, adjusting a layer thickness of a deposited layer of the build material (150), adjusting an amount of printing agent deposited on the build region (151) by a printing agent dispenser (FIG. 2, 180), adjusting a torque output by a material spreader (FIG. 2, 120), activating an electromagnetic wave source such as an energy emitting device (FIG. 2, 160), removing protrusions from the along the x,y plane with an ablation laser (FIG. 2, 127), heating the build material (150) with the ablation laser (FIG. 2, 127), abandoning the build of a layer of the part (101), abandoning the build of the part (101) altogether, initiating a new build of the part (101), adjusting the printing parameters of a print agent, correcting operation of a translatable device (120, 140, 160, 180), replacing the translatable device (120, 140, 160, 180), presenting a warning of a drag event to a user, tagging the part (101) as a confirmed draggable part, and combinations thereof.

Even further, the executable code may, when executed by the controller (250), detect a change in a process parameter associated with the operation of the layer deposition device including observing violations of an upper control limit (UCL) and a lower control limit (LCL). The UCL and the LCL may be thresholds set by the sensor data analysis module (114) to determine when the protrusion (102) exceeds a height that may cause a part drag instance or when the process parameters detected by the sensor (112) and analyzed by the sensor data analysis module (114) indicate a change in in the process parameters indicative of a part lift instance and/or a part drag instance. The image capture device (152) may be used to capture a number of images of the build region (151) acting as a sensor (112) or in concert with the sensors (112), and the sensor data analysis module (114) may determine the height of the protrusion (102) and whether the protrusion (102) exceeds a height that may cause a part drag instance.

In some examples, different printed parts may produce a different signal in terms of the detection of the drag via the sensors (112) and the sensor data analysis module (114). For example, the build may include user-desired parts that the user seeks to be printed, and may also include control parts such as posts, which are deeply embedded in the bed. The control parts may send stronger signals than the user-defined parts which may have completed fewer layers of build as compared to the posts (e.g., a few layers). Thus, it may be beneficial, in some examples, to compare variances in the process parameters associated with the layer deposition devices' (110, 120, 140, 160, 180) interaction with the control parts with the process parameters associated with the layer deposition devices' (110, 120, 140, 160, 180) interaction with the user-desired parts in order to determine what an abnormal sensed process parameter is that may be detected in the user-desired parts as compared to a baseline or control sensed process parameter that may be detected in the control parts.

In one example, the UCL and LCL threshold may include greater than 3σ from a mean value in order to obtain meaningful and identifiable variations from the control. In another example, the clustering of points around 2σ from the mean and/or whether the data points are consecutive may be indicative of abnormality in the process parameters. In one example, a sample size of at least 2 may be obtained. The UCL may be set at a slew torque of 263.61 newton meters (N·m) and the LCL may be set at 0.0 N·m, with an average slew torque of 124.67 N·m. The UCL and the LCL may be adjusted as the build material (150), the specific additive manufacturing device (200) being used to build the part, and architectures of the part change. Determining violations in instances where one build material (150) or one additive manufacturing device (200) may prove helpful in connection with predicting changes for the other build materials (150) and additive manufacturing devices (200).

These and other functions of the executable code, when executed by the controller (250), are performed according to the methods of the present specification described herein. In the course of executing code, the controller (250) may receive input from and provide output to a number of the remaining hardware units.

The data storage device (251) may store data such as executable program code that is executed by the controller (250) or other processing device. As will be discussed, the data storage device (251) may specifically store computer code representing a number of applications that the controller (250) executes to implement at least the functionality described herein. The data storage device (251) may include various types of memory modules, including volatile and nonvolatile memory. For example, the data storage device (251) of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device (251) as may suit a particular application of the principles described herein. In certain examples, different types of memory in the data storage device (251) may be used for different data storage needs. For example, in certain examples the controller (250) may boot from Read Only Memory (ROM), maintain nonvolatile storage in the Hard Disk Drive (HDD) memory, and execute program code stored in Random Access Memory (RAM). The data storage device (251) may include a computer readable medium, a computer readable storage medium, or a non-transitory computer readable medium, among others. For example, the data storage device (251) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The additive manufacturing device (200) further includes a number of elements used to form the parts (101) within the build region (151). The additive manufacturing device (200) may include a build platform (202). The build platform (202) may move in the z-direction indicated by arrow (191). More specifically, the build platform (202) may move in the downward z-direction as indicated by arrow (191) to allow for successive layers of build material (150) and printing agent to be deposited at the same level as every other layer of deposited build material (150) and printing agent. In one example, the build platform (202) may move between 60 and approximately 100 micrometers (μm) in the downward direction between sequential layers of deposited build material (150).

The additive manufacturing device (200) may include a material spreader (120) and at least one hopper (140) movably coupled to a carriage (201) and translatable in the X-direction indicated by arrow (190). The material spreader (120) and hopper (140) may make a plurality of passes over the build platform (202) dispensing and spreading build material (150) across the build platform (202), and the carriage (201) may be used to move the material spreader (120) and the hopper (140) in either direction as indicated by arrow (190) as it may be instructed by the controller (250).

The material spreader (120) may be, for example a roller that spans one planar dimension of the build platform (202) to form a level and uniform layer of the build material (150) along the surface of the build platform (202). In one example where the material spreader (120) is a roller, the roller may counter-rotate such that the roller rotates in a direction opposite to its movement relative to the build platform (202). Throughout this description, the terms “material spreader” and “roller” may be used interchangeably.

A hopper (140) may be any device that dispenses an amount of build material for spreading by the material spreader (120). In one example, the hopper (140) may deposit build material (150) in front of and behind the material spreader (120) as the hopper (140) and the material spreader (120) translate above and across the build platform (202). Thus, the hopper (140) may dispense a plurality of doses of the build material in front of the progression of the material spreader (120) as the material spreader (120) is moved over the build platform (202). Although one hopper (140) is depicted in FIG. 2, any number of hoppers (140) may be included in the additive manufacturing device (200). In one example, the hopper (140) may be moved between a front and behind position relative to the movement of the material spreader (120) so that the hopper (140) may dispense the build material (150) in front of and behind the material spreader (120) relative to the materials spreader's direction of travel across the build platform (202). Arrow (190) indicates that the material spreader (120) and the hoppers (140) may move bi-directionally in the X-direction such that material may be dispensed and spread along the build platform (202) in two directions of travel. Throughout the specification and figures, the right direction of arrow (190) is the positive x-direction, and the left direction of arrow (190) is the negative x-direction. Further, the up direction of arrow (191) is the positive z-direction, and the down direction of arrow (191) is the negative z-direction.

In one example, a stage (204) may be included on either side of the build platform (202) to allow for build material (150) to be deposited on the stage (204), and spread from the stage (204) to the build platform. In one example, an amount or dose of build material (150) may be deposited on either side of the build platform (202) and on the stage (204), and the material spreader (120) may spread the build material (150) from the stage (204) from either X-direction as indicated by arrow (190). In one example, the hopper (140) may spread build material (150) over the build platform (202). In one example, excess build material (150) may be staged or deposited on either side of the stage (204) before being spread over the build platform (202) to allow the material spreader (120) to spread this build material (150) in a subsequent pass over the build platform (202) and stage (204).

The additive manufacturing device (200) may also include a controller (250) used to control the functions and movement of the various elements of the additive manufacturing device (200) described herein. For example, the controller (250) may control the movement of the carriage (201) and, in turn, the movement of the build material dispensing device (201) and its elements over the stage (204) and build platform (202). Further, the controller (250) may control the movement of the build platform (202) relative to the stage (204). Still further, the controller (250) may control the quantity of build material (150) and printing agent deposited by the elements moveably coupled to the carriage (201).

The build platform (202) may be supported by build platform base (203). The build platform (202) and/or the build platform base (203) may be moveably coupled to the stage (204) to allow for the build platform (202) and the build platform base (203) to be moved up and down in order to form layers of the 3D object with the build material (150) and the agent.

The material spreader (120) and the hoppers (140) which form the additive manufacturing device (200) are moveably coupled to the carriage (201). The carriage (201) may traverse a length of the additive manufacturing device (200) so that the additive manufacturing device (200) may move over the entirety of the build platform (202). The carriage (201) may include a carriage drive shaft, a carriage coupling device and other devices to couple a material spreader (120), the hoppers (140), an energy emitting device (160), a printing agent dispenser (180), or combinations thereof to the carriage (201). In one example, a plurality of carriages (201) may be included on the additive manufacturing device (200) to move the material spreader (120), the hoppers (140), the energy emitting device (160), and the printing agent dispenser (180), independently or collectively.

The additive manufacturing device (200) may also include an energy emitting device (160). The energy emitting device (160) is moveably coupled to the carriage (201) and may move along with the additive manufacturing device (200) in order to warm the build material (150) and/or fuse, sinter, bind, or cure the build material (150). Thus, the energy emitting device (160) may be any device that emits electromagnetic energy at any wavelength to warm and/or fuse or sinter the build material (150), a printing agent; and a combination of build material and printing agent. In one example, the energy emitting device (160) may include at least one warming lamp (161) that emits electromagnetic energy sufficient to warm the build material (150) deposited or spread along the surface of the stage (204) and the build platform (202). Warming of the build material (150) serves to prepare the build material (150) for solidification including, for example binding or thermal fusing. Further, the electromagnetic radiation from the warming lamp (161) serves to maintain the build material (150) and the object being formed from the build material (150) at a relatively more uniform and non-fluctuating temperature. In the case of thermal binding systems, if the build material (150) and the object being formed are allowed to cool or otherwise fluctuate in temperature, the part (101) or layers thereof may become warped, and this warping may form the protrusions (102) of the part (101).

The energy emitting device (160) may also include at least one fusing lamp (163). The fusing lamp (163) emits electromagnetic energy sufficient to fuse the build material (150) together through the use of the printing agent. Fusing of the build material a layer at a time serves to form the part (101) (i.e., a 3D object). With the warming lamp (161) warming the build material (150), the fusing lamp (163) may fuse the build material (150) where the printing agent has been printed and in all coordinate directions within the part (101) including between layers of fused build material (150) by allowing the warming lamp (161) to keep previous, solidified layers at a fusible temperature and fusing the build material (150) spread across the previous, fused layer to fuse to the layer of build material (150) to the previous layer. In one example, the energy emitting device (160) may include one warming lamp (161) and three fusing lamps (163). In one example, the fusing lamps (163) may remain on or activated during the build processes described herein. The build material (150), without fusing or printing agents deposited thereon, may absorb a small amount of energy from the fusing lamps. In another example, the voltage to the fusing lamps (163) may be lowered when the build platform (202) is being warmed or a fusing or binding process is not being performed in order to reduce power consumption.

The additive manufacturing device (200) may also include a printing agent dispenser (180) to dispense a printing agent onto the build material (150) spread along the surface of the build platform (202). The printing agent may include, for example, active ingredients, detailing agents (DA), fusing agents, sintering agents, other printing agents, and combinations thereof, that may be used to bring about the fusing or sintering of the build material (150) and compensate for a rise in temperature among the layers of the part being printed. The printing agent dispenser (180) may be moveably coupled to the carriage (201), and may move with the energy emitting device (160) over the surface of the build platform (202). The printing agent dispenser (180) may include at least one fluidic die (181-1, 181-n, collectively referred to herein as 181) used to dispense a volume of the printing agent onto the build material (150). In the example of FIG. 2, the printing agent dispenser (180) includes two fluidic die (181-1, 181-n), but may include any number of fluidic die (181) as denoted by the “n” in 181-n. In one example, the fluidic die (181) may be digitally addressable such that the printing agent may be dispensed on the build material (150) that is spread across the surface of the build platform (202) in a pattern as defined by part data (252) provided to the additive manufacturing device (200). Wherever the fluidic die (181) of the printing agent dispenser (180) dispenses the printing agent onto the build material (150) spread across the build platform (202), the fusing lamp (163) will fuse the build material (150) and form a layer of the 3D object.

The additive manufacturing device (200) may also include logic and circuitry to cause the material spreader (120), the hopper (140), the energy emitting device (160), the printing agent dispenser (180), the build platform (202), and the build platform base (203) to move and actuate in a manner that produces the part (101) based on part data (252) stored in a data storage device (251) of the additive manufacturing device (200). For example, the additive manufacturing device (200) may include the controller (250). The controller (250) may include the hardware architecture to retrieve executable code from the data storage device (251) and execute the executable code as described herein. The executable code may, when executed by the controller (250), cause the controller (250) to implement at least the functionality of sending signals to the material spreader (120), the hopper (140), the energy emitting device (160), the printing agent dispenser (180), the build platform (202), and the build platform base (203) to instruct these devices to perform their individual functions according to the methods of the present specification described herein. In the course of executing code, the controller (250) may receive input from and provide output to a number of the remaining hardware units.

The part data (252) stored in the storage device (251) may be obtained from an external source such as, for example, a computer-aided design (CAD) system that provides a CAD model of the 3D object defined by the part data (252) and may be in any format such as, for example, a 3D printing file format, a 3D manufacturing format (3MF) file format, stereolithography (STL) file format, additive manufacturing format (AMF) file format, Wavefront Object (OBJ) file format, virtual reality modeling language (VRML) file format, X3D XML-based file format, Filmbox (FBX) file format, initial graphics exchange specification (IGES) file format, ISO 10303 (STEP) file format, point cloud data from a 3D scan of an object, other types of 3D printing file formats, and combinations thereof. The build layer process (253) may be any data stored in the data storage device (251) that defines the process the controller (250) follows in instructing the material spreader (120), the hopper (140), the energy emitting device (160), the printing agent dispenser (180), the build platform (202), and the build platform base (203) to produce the part (101) over a number of build material (150) and printing agent layers.

The material spreader (120) may include a material spreading roller that counter-rotates such that it rotates in a direction opposite to its movement relative to the build platform. Thus, if the additive manufacturing device (200) including the material spreader (120) and the hopper (140) move in the positive x-direction as indicated by arrow (190), then the roller will rotate in the direction of arrow A. In contrast, if the additive manufacturing device (200) including the material spreader (120) and the hopper (140) move in the negative x-direction as indicated by arrow (190), then the roller will rotate in the direction of arrow B.

In addition, the additive manufacturing device (200) may include an ablation laser (127). The ablation laser (127) may be used to remove the protrusion (102) of the part (101). The ablation laser (127) may emit electromagnetic radiation (127) sufficient to ablate material. Thus, the ablation laser (127) may be any laser device that can remove or sublimate material from a solid surface by irradiating it with a culminated beam of electromagnetic radiation. At low laser flux, the fused or sintered build material may be heated by the absorbed laser energy and evaporates or sublimates. At high laser flux, the fused or sintered build material may be converted to a plasma. Thus, laser ablation refers to removing material with a pulsed laser, or ablating material with a continuous wave laser beam in situations where the laser intensity is high enough. Excimer lasers of deep ultra-violet light may be used in photoablation, and may output wavelengths of approximately 200 nm. Further, in some examples, the ablation laser (127) may be used to quickly heat the build material (150) in locations within the build region (151) where the build material has cooled in order to stop the formation of a protrusion (102) on the part (101) and reduce or eliminate the likelihood of a drag event occurring.

The additive manufacturing device (200) may further include a number of modules used in the implementation of the methods and systems described herein. The various modules within the additive manufacturing device (200) include executable program code that may be executed separately. In this example, the various modules may be stored as separate computer program products. In another example, the various modules within the additive manufacturing device (200) may be combined within a number of computer program products; each computer program product including a number of the modules.

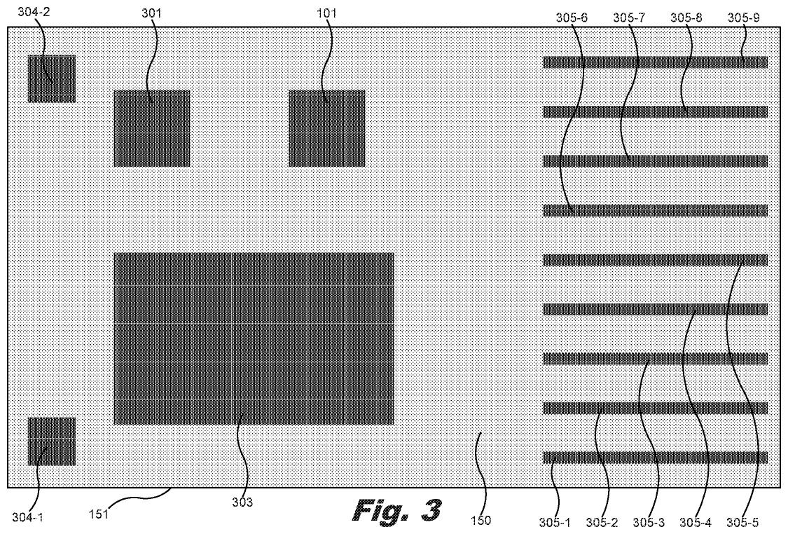

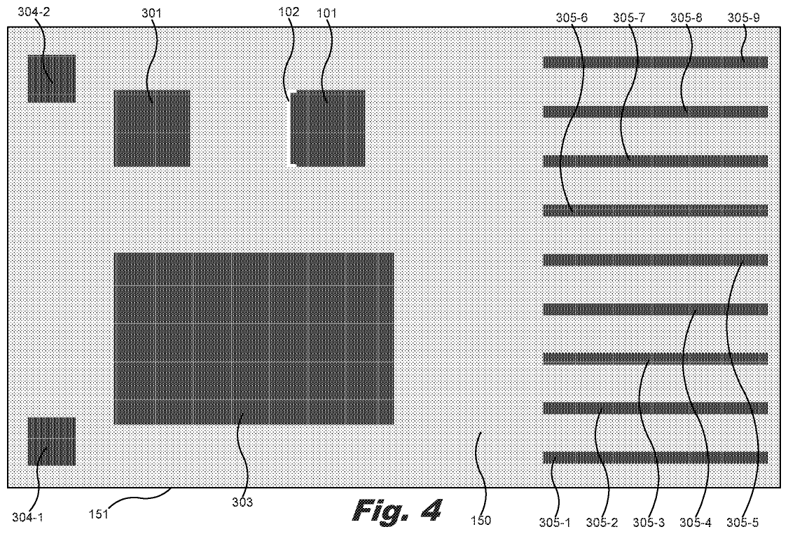

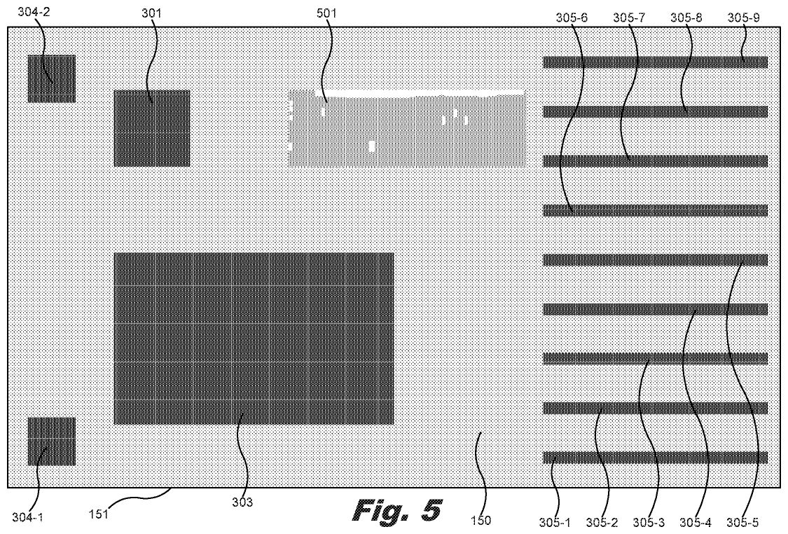

The additive manufacturing device (200) may include the sensor data analysis module (114) described herein. The function of the sensor data analysis module (114) and the remainder of the elements of the additive manufacturing device (200) will now be described in connection with FIGS. 3 through 5. FIG. 3 is a block diagram of an image of a build region (151) including a number of parts (101, 301, 303, 304-1, 304-2, 305-1, 305-2, 305-3, 305-4, 305-5, 305-6, 305-7, 305-8, 305-9, collectively referred to herein as 101) being printed, according to an example of the principles described herein. Further, FIG. 4 is a block diagram of an image of a build region (151) including a number of parts (101) being printed and with a protruding portion (102) of one of the parts (101), according to an example of the principles described herein. FIG. 5 is a block diagram of an image of a build region (151) including a number of parts (101) being printed and with one of the parts (101) being subjected to a drag instance (501), according to an example of the principles described herein.

FIGS. 3 through 5 may be sequential layers of build materials applied to one another in the z-direction (FIG. 2, 191) such as, for example, layers 1259, 1260, and 1261 of the build, respectively. Further, each of the parts (101, 301, 303, 304-1, 304-2, 305-1, 305-2, 305-3, 305-4, 305-5, 305-6, 305-7, 305-8, 305-9) have begun to be printed with part (101) being the target part that FIGS. 3 through 5 are described herein as experiencing a lifting and dragging instance.

At layer 1259 depicted in FIG. 3, no protrusions are present. FIG. 3 may serve as a control (300) which includes the build region (151) where no parts or a number of calibration parts such as parts (304-1, 304-2, 303, 305-1, 305-2, 305-3, 305-4, 305-5, 305-6, 305-7, 305-8, 305-9) are depicted. This control (300) may serve as a baseline as to the sensed process parameters of the layer deposition devices (110, 120, 140, 160, 180) within the build region (151) look under nominal operating conditions where no lift instances (102) (i.e., protrusions (102)) or drag instances (501) occur. The data sensed by the sensor (112) at FIG. 3 as the control data of the control (300) may be compared to the measured process parameters sensed in subsequent layers such as those in FIGS. 4 and 5. Any change in the process parameters from the control (300) of FIG. 3 may indicate a protrusion (102) in the part (101) or a drag instance (501) as analyzed by the sensor data analysis module (114).

In one example, a moving range (MR) control chart may be used to precisely describe sequential variance in the data sensed by the sensor (112). An MR control chart is a graphical way to filter out routine variation in a process. Filtering out routine variation assists individuals in determining whether a process is stable and predictable. If the variation is more than routine, the process may be adjusted to create higher quality output at a lower cost.

All processes exhibit variation as the process is measured over time. There are two types of variation in process measurements. One type of variation in process measurements is routine or common-cause variation. Even measurements from a stable process exhibit these random fluctuations, and when process measurements exhibit common-cause variation, the measurements stay within expected limits. The other type of variation in process measurements is abnormal or special-cause variation. Examples of special-cause variation include a change in the process mean, points above or below the control limits such as the UCL and LCL, or measurements that trend up or down. These changes may be caused by factors such as a broken tool or machine such as within the layer deposition devices (120, 140, 160, 180), equipment degradation, and changes to raw materials such as the build material (150) or printing agents deposited by the printing agent dispenser (180). A change or defect in the process may be identifiable by abnormal variation in the process measurements.

Control charts quantify the routine variation in a process, so that special causes can be identified. In one example, control charts filter out routine variation by applying control limits. Control limits define the range of process measurements for a process that is exhibiting routine variation. Measurements between the control limits indicate a stable and predictable process. Measurements outside the limits indicate a special cause, and action may be taken to restore the process to a state of control. Control chart performance may be dependent on the sampling scheme used. The sampling scheme may be rational, that is, the subgroups are representative of the process. Rational subgrouping means that samples from the process are obtained by selecting subgroups in such a way that special causes are more likely to occur between subgroups rather than within subgroups.

In FIG. 4, a protrusion (102) is detected in part (101) of FIG. 4 as the part (101) is being built. As the layer deposition devices (110, 120, 140, 160, 180) traverse the build region (151), their respective process parameters may be sensed by the sensor (112) and the sensor data analysis module (114) may determine if a change in the process parameters of the layer deposition devices (110, 120, 140, 160, 180) have varied outside any thresholds such as the UCL and the LCL. The variation in the sensed process parameters may be indicative of a lift instance (102) or a drag instance (501). The sensor data analysis module (114) may be executed by the controller (150) in order to make this determination. As described herein, a number of thresholds may be set by the user or included as executable code within the sensor data analysis module (114) as to what variance or change in the process parameters indicates that a lift instance (102) or a drag instance (501) has occurred.

In one example, the sensor data analysis module (114) may be able to determine the height of the protrusion (FIG. 4, 102) based on the amount at with the process parameter varies. Again, the image capture device (152) may be used to capture a number of images of the build region (151) acting as a sensor (112) or in concert with the sensors (112), and the sensor data analysis module (114) may determine the height of the protrusion (102) and whether the protrusion (102) exceeds a height that may cause a part drag instance. The height of the protrusion (102) may be indicative of the severity of the lift of the part (101) (i.e., the protrusion (102)) and may be used to determine how much energy may be used by the ablation laser (127) to remove the protrusion (102). Further, the height of the protrusion (102) may be used to determine whether the protrusion (102) will come into contact with any of the layer deposition devices (110, 120, 140, 160, 180) of the additive manufacturing device (100, 200). Correlating data that defines the correlation between temperature within the part (101) and the height of the protrusion (102) that forms the lift instance (102) or a drag instance (501) may be stored in a look-up table in, for example, the data storage device (251).

FIG. 5, being a layer after the layer depicted in FIG. 4, may include the drag instance (501). In the example of FIG. 5, the dragging (501) has occurred because the protrusion (102) of the part (101) was above a threshold where any one or a combination of the layer deposition devices (110, 120, 140, 160, 180) pulled the part (101) through the build material (150). The dragging (501), in this example, has ruined or disturbed at least one layer of the build material (150), and could possibly damage other parts (101) such as parts (305-6, 305-7, 305-8, 305-9) that are also being printed and are located near the part (101). Further, the dragged part (101) may damage any of the layer deposition devices (110, 120, 140, 160, 180) if they are the devices that drag the part (101) or even if they come into contact with the dragged part (101) after the dragging (501) has occurred.

The process parameters may include, for example, power levels of the energy emitting device (FIG. 2, 163), scan speeds of the energy emitting device (FIG. 2, 163), warming lamp (FIG. 2, 161) power levels, warming lamp (FIG. 2, 161) scan speeds, a pulse-width modulation used to control the activation of the warming lamp (FIG. 2, 161), build material (150) temperatures, humidity levels, build material (150) dose volumes, material spreader (FIG. 2, 120) rotation velocities, material spreader (FIG. 2, 120) transverse velocities, material spreader (FIG. 2, 120) slew torque, fusing agent density levels, cooling agent density levels, build material (150) melting points, build material (150) crystallization temperatures, build material (150) conductivity, build material (150) thermal mass values, build material (150) thermal properties, build material (150) densities, build material (150) flowability, build material (150) friction properties, build material (150) mechanical properties, part model (e.g., part data (252)) used, a number of layers assigned to a core of the part model used, a number of layers assigned to a mantle of the part model used, a number of layers assigned to a shell of the part model used, part post processing methods used, percentage of part expansion of an original geometry of the part, percentage of part dilation of the original geometry of the part, or combinations thereof.

The sensor data analysis module (114) may also determine, based on the data obtained by the sensor (112), whether a change in a process parameter associated with the operation of the layer deposition device (110, 120, 140, 160, 180) indicates that a lift instance (102) or a drag instance (501) has occurred and, in response to a determination that the lift instance (102) or the drag instance (501) has occurred, taking a remedial action to correct the lift instance (102) or a drag instance (501). The remedial measures may include, for example, adjusting a layer thickness of a deposited layer of the build material (150), adjusting an amount of printing agent deposited on the build region (151) by a printing agent dispenser (FIG. 2, 180), adjusting a torque output by a material spreader (FIG. 2, 120), activating an electromagnetic wave source such as the energy emitting device (FIG. 2, 160), removing protrusions from the along the x,y plane with an ablation laser (FIG. 2, 127), abandoning the build of a layer of the part (101), abandoning the build of the part (101) altogether, initiating a new build of the part (101), adjusting the printing parameters of a print agent, correcting operation of a layer deposition device (110, 120, 140, 160, 180), replacing the translatable device (120, 140, 160, 180), presenting a warning of a drag event to a user, tagging the part (101) as a confirmed draggable part, and combinations thereof.

The sensor data analysis module (114) may also determine whether the protrusion (102) of the part (101) along the x,y plane of the build region (151) will come into contact with a layer deposition device (110, 120, 140, 160, 180). In response to a determination that the protrusion (102) of the part (101) will come into contact with the layer deposition device (110, 120, 140, 160, 180), the sensor data analysis module (114) may take the remedial actions described herein or combinations thereof.

In an example where the sensed layer deposition device (110, 120, 140, 160, 180) is the energy emitting device (FIG. 2, 160), the energy emitting device (FIG. 2, 160) may employ a temperature sensor as the sensor (112) in order to detect the temperature of the build material. In one example, the temperature sensor may include a thermal imaging device such as a forward-looking infrared (FLIR) camera. In this example, the energy emitting device (FIG. 2, 160) may operate at least partially based on feedback from the thermal imaging device. The build material (150) between the two posts (304-1, 304-2) depicted in FIGS. 4 through 6 may be used to detect the variations in the temperature of the build material (150) within the build region (151) from a target temperature and this sensed temperature of the build material (150) may serve as a baseline temperature for the remainder of the build material (150) within the build region (151). Further, the temperature of the two posts (304-1, 304-2) may serve as a baseline of the temperatures of the parts (101, 301, 303, 305-1, 305-2, 305-3, 305-4, 305-5, 305-6, 305-7, 305-8, 305-9) within the build region (151). If the measured temperature of the build material (150) is below the target temperature, then a signal may be sent to the energy emitting device (FIG. 2, 160) to increase the power to the energy emitting device (160) and/or adjust the pulse width modulation of the energy emitting device (160). Similarly, if the measured temperature of the two posts (304-1, 304-2) is below the target temperature, then a signal may be sent to the energy emitting device (FIG. 2, 160) to increase the power to the energy emitting device (160) or its pulse width modulation in order to ensure that the parts (101) do not cool to a level where the part (101) may be subjected to a lift instance (102) and/or a drag instance (501). In instances where the sensor (112) senses a temperature of the build material (150) or the parts (101) as being outside a threshold such as the UCL or the LCL, the sensor data analysis module (114) may identify this abnormality and report this condition to the controller (250). The controller (250) may instruct the energy emitting device (160) to cease operation in order to remedy the lift instance (102) and/or a drag instance (501).

In an example where the sensed layer deposition device (110, 120, 140, 160, 180) is the material spreader (FIG. 2, 120), the additive manufacturing device (100, 200) may employ a force sensor or similar device to sense the slew torque of the material spreader (FIG. 2, 120). In this example, the material spreader (FIG. 2, 120) may operate at least partially based on feedback form the slew torque-sensing force sensor. As the material spreader (FIG. 2, 120) translates across the build region (151), the sensor (112) may continually sense the slew torque of the material spreader (120). If the material spreader (120) comes into contact with a protruding portion (102) of the part (101) and/or drags the part (101) any distance along the build region (151), the slew torque will change due to the resistance the material spreader (120) experiences. The sensor (112) may detect this resistance as a change in the slew torque, and the sensor data analysis module (114) may determine that the resistance is indicative of a lift instance (102) and/or a drag instance (501). The sensor data analysis module (114) may provide this information to the controller (250), and the controller (250) may instruct the material spreader (120) to cease operation in order to remedy the lift instance (102) and/or a drag instance (501).

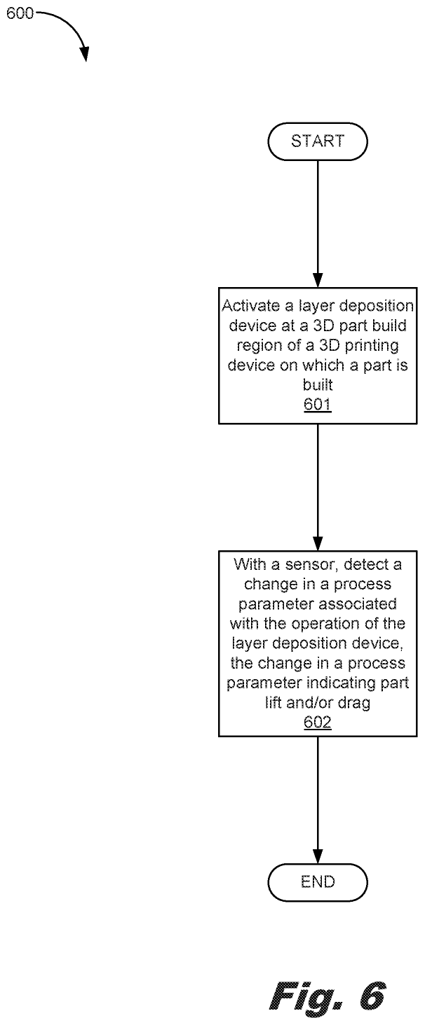

Having described the elements of the additive manufacturing device (100, 200), the methods associated with the additive manufacturing device (100, 200) will now be described. FIG. 6 is a flowchart showing a method (600) of detecting three-dimensional (3D) part lift and drag, according to an example of the principles described herein. The method (600) may include activating (block 601) a layer deposition device (110, 120, 140, 160, 180) at a 3D part build region (151) of a 3D printing device (100, 200) on which a part (101) is built. The method (600) may also include, with a sensor (112), detecting (block 602) a change in a process parameter associated with the operation of the layer deposition device (110, 120, 140, 160, 180), the change in a process parameter indicating part lift (102) and/or part drag (501). In one example, the sensor (112) may detect (block 602) a change in a process parameter associated with the operation of the layer deposition device (110, 120, 140, 160, 180) where the change in the process parameter indicates a lift instance (102) and/or a drag instance (501).

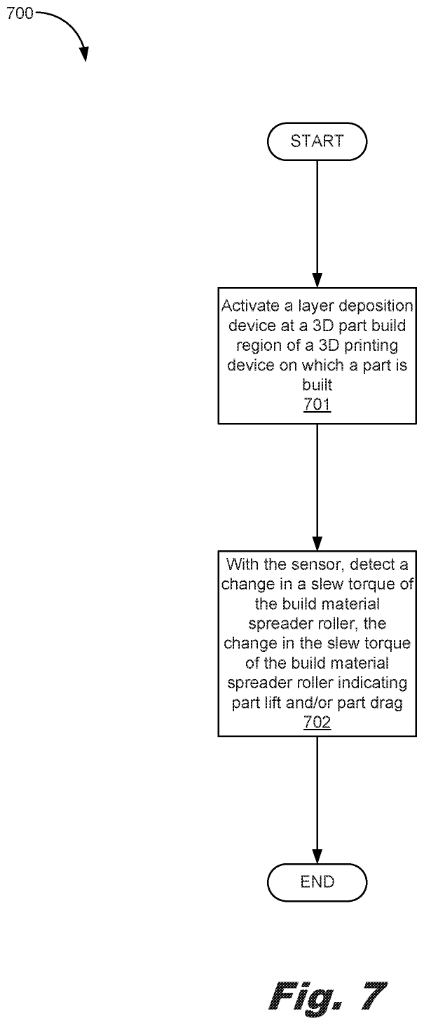

FIG. 7 is a flowchart showing a method (700) of detecting 3D part lift (102) and drag (501), according to an example of the principles described herein. The method (700) may include activating (block 701) a layer deposition device (110, 120, 140, 160, 180) at a 3D part build region (151) of a 3D printing device (100, 200) on which a part (101) is built. The method (700) may also include, with a sensor (112), detecting (block 702) a change in a slew torque of the build material spreader roller (120). The change in the slew torque of the build material spreader roller (120) indicates a lift instance (102), a drag instance (501), or combinations thereof. In this manner, the process parameter of the spreader roller (120) may be used to determine whether a lift instance (102) and/or a drag instance (501) exists within the build taking place in the build region (151) of the additive manufacturing device (100, 200).

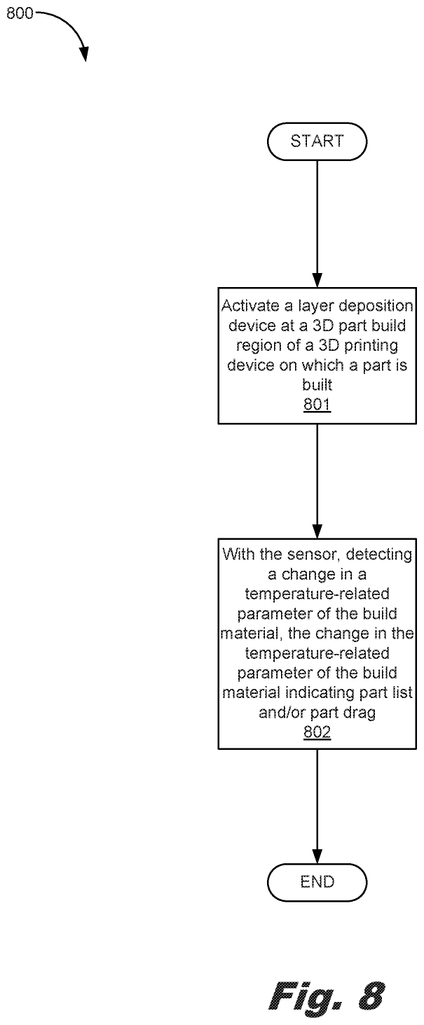

FIG. 8 is a flowchart showing a method (800) of detecting 3D part lift (102) and drag (501), according to an example of the principles described herein. The method (800) may include activating (block 801) a layer deposition device (110, 120, 140, 160, 180) at a 3D part build region (151) of a 3D printing device (100, 200) on which a part (101) is built. The method (800) may also include, with a sensor (112), detecting (block 802) a change in a temperature-related parameter of the build material (150). The change in the temperature-related parameter of the build material indicates a lift instance (102) and/or a drag instance (501). The temperature-related parameter may include an adjustment of the pulse-width modulation used to control the activation of the energy emitting device (FIG. 2, 160), data analysis provided by the sensor data analysis module (114) in connection with data received from the sensor (112) such as a thermal image as captured by the sensor (112), and combinations thereof.

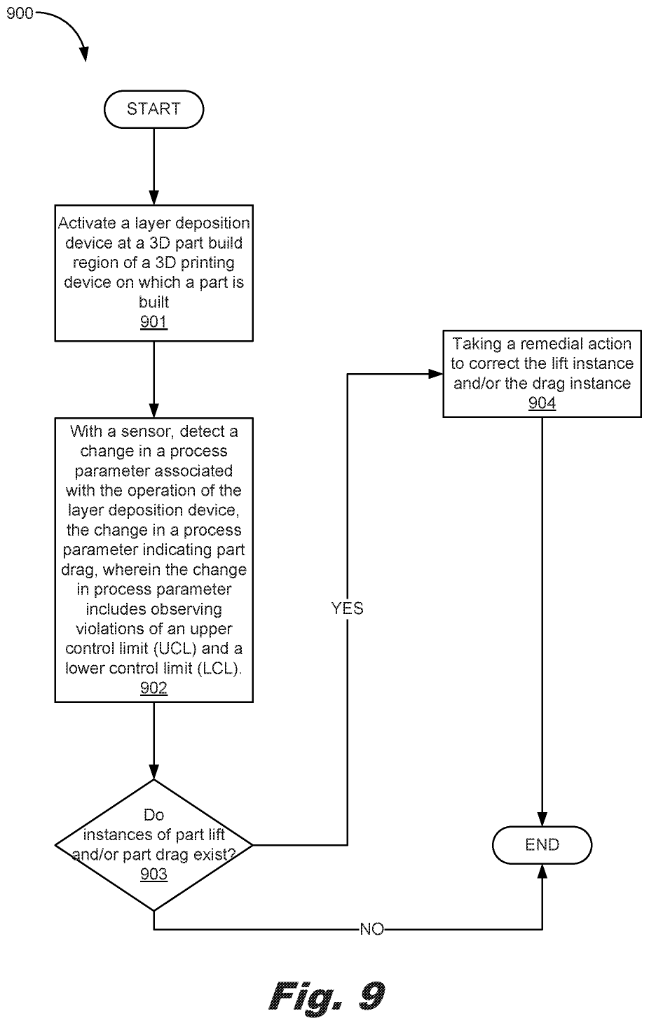

FIG. 9 is a flowchart showing a method (900) of detecting 3D part lift (102) and drag (501), according to an example of the principles described herein. The method (900) may include activating (block 901) a layer deposition device (110, 120, 140, 160, 180) at a 3D part build region (151) of a 3D printing device (100, 200) on which a part (101) is built. With a sensor (112), the method (900) may include detecting (block 902) a change in a process parameter associated with the operation of the layer deposition device (110, 120, 140, 160, 180). The change in the process parameter indicates a lift instance (102), a drag instance (501), or combinations thereof, where the change in the process parameter includes observing violations of an upper control limit (UCL) and a lower control limit (LCL). In this example, the sensor data analysis module (114) may determine whether the data provided by the sensor (112) that is used to measure the process parameters of the layer deposition device (110, 120, 140, 160, 180) is outside the thresholds of the UCL and LCL.

The method (900) may also include determining (block 903) if instances of part lift (102) and/or part drag exist (501). A part lift instance (102) and/or a part drag instance (501) may exist in instances where the process parameter has moved outside the UCL, the LCL, or another threshold. Thus, in response to a determination that a part lift instance (102) and/or a part drag instance (501) does not exist (block 903, determination NO), the method (900) may terminate. If, however, the a part lift instance (102) and/or a part drag instance (501) does exist (block 903, determination YES), then the controller (250) may instruct the elements of the additive manufacturing device (100, 200) to take a remedial action (block 904) to correct the lift instance (201), the drag instance (501), and combinations thereof. The remedial measures may include, for example, adjusting a layer thickness of a deposited layer of the build material (150), adjusting an amount of printing agent deposited on the build region (151) by a printing agent dispenser (FIG. 2, 180), adjusting a torque output by a material spreader (FIG. 2, 120), activating an electromagnetic wave source such as an energy emitting device (FIG. 2, 160), removing protrusions from the along the x,y plane with an ablation laser (FIG. 2, 127), heating the build material (150) with the ablation laser (FIG. 2, 127), abandoning the build of a layer of the part (101), abandoning the build of the part (101) altogether, initiating a new build of the part (101), adjusting the printing parameters of a print agent, correcting operation of a translatable device (120, 140, 160, 180), replacing the translatable device (120, 140, 160, 180), presenting a warning of a drag event to a user, tagging the part (101) as a confirmed draggable part, and combinations thereof.

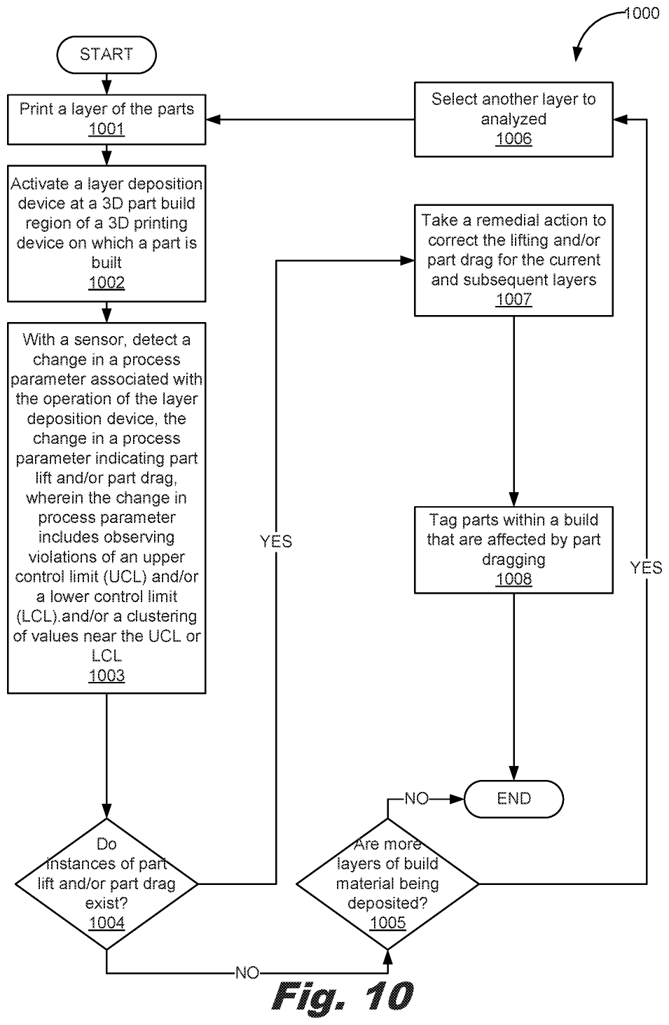

FIG. 10 is a flowchart showing a method (1000) of detecting 3D part lift (102) and drag (501), according to an example of the principles described herein. The method (1000) may include printing (block 1001) a layer of the part(s) (101) included in the build, and activating (block 1002) a layer deposition device (110, 120, 140, 160, 180) at a 3D part build region (151) of a 3D printing device (100, 200) on which a part (101) is built. With a sensor (112), the method (1000) may include detecting (block 1002) a change in a process parameter associated with the operation of the layer deposition device (110, 120, 140, 160, 180). The change in the process parameter indicates a lift instance (102), a drag instance (501), or combinations thereof, where the change in the process parameter includes observing violations of an upper control limit (UCL) and a lower control limit (LCL). In this example, the sensor data analysis module (114) may determine whether the data provided by the sensor (112) that is used to measure the process parameters of the layer deposition device (110, 120, 140, 160, 180) is outside the thresholds of the UCL and LCL.

It may be determined (block 1004) if instances of part lift (102) and/or part drag exist (501). In response to a determination that a part lift instance (102) and/or a part drag instance (501) does not exist (block 1004, determination NO), the method (1005) may include determining (block 1005) whether more layers of build material (150) are being deposited. In contrast, in response to a determination that a part lift instance (102) and/or a part drag instance (501) does exist (block 1004, determination YES), then the controller (250) may instruct the elements of the additive manufacturing device (100, 200) to take a remedial action (block 1007) to correct the lift instance (201), the drag instance (501), and combinations thereof.

In response to a determination that more layers of build material (150) are not being deposited (block 1005, determination NO), then the method (1000) may terminate. The method (1000) may also include tagging (block 1008) or otherwise identify parts (101) within a build that are affected by part dragging (FIG. 5, 501). In one example, output data from the image capture device (152) as analyzed by the sensor data analysis module (114) may be used in determining which parts (101) have been dragged (501) in order to identify to the controller (250) which parts are to be tagged (block 1008). The tagging (block 1008) of the parts (101) that were affected by part dragging may assist in identifying parts (101) that may not be able to be printed or that may be difficult to print given their history, and may assist in reforming the part and/or changing process parameters in the additive manufacturing device (100, 200). Thus, the tagging (block 1008) of the parts (101) may allow the additive manufacturing device (100, 200) to abandon the printing of a current layer of the part (101) or abandon the part altogether.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the controller (250 of the additive manufacturing device (100, 200) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a system for detecting three-dimensional (3D) part drag includes a layer deposition device, and a sensor to detect a change in a process parameter associated with the operation of the layer deposition device within a 3D part build region of a 3D printing device on which a part is built, the change in a process parameter indicating part drag.

The preceding description has been presented to illustrate and describe examples of the principles described. This description is not intended to be exhaustive or to limit these principles to any precise form disclosed. Many modifications and variations are possible in light of the above teaching.

What is claimed is:

1. A system for detecting three-dimensional (3D) part drag, comprising:
a layer deposition device; and
a sensor to detect a change in a process parameter associated with the operation of the layer deposition device within a 3D part build region of a 3D printing device on which a part is built, the change in a process parameter indicating part drag.

2. The system of claim 1, wherein the layer deposition device comprises an energy emitting device, a build material spreader roller, or combinations thereof.

3. The system of claim 1, wherein:
the layer deposition device comprises a build material spreader roller;
the sensor detects a change in a slew torque of the build material spreader roller; and
the change in the slew torque of the build material spreader roller indicates part drag.

4. The system of claim 1, wherein:
the layer deposition device comprises a build material warming lamp;
the sensor detects a change in a temperature-related parameter of the build material; and
the change in the temperature of the build material indicates part drag.

5. The system of claim 4, wherein the temperature-related parameter of the build material comprises a pulse-width modulation used to control the activation of the build material warming lamp, the pulse-width modulation defining how the build material warming lamp reacts to a change in temperature of the build material.

6. A method of detecting three-dimensional (3D) part drag, comprising:
activating a layer deposition device at a 3D part build region of a 3D printing device on which a part is built; and
with a sensor, detecting a change in a process parameter associated with the operation of the layer deposition device, the change in a process parameter indicating part drag.

7. The method of claim 6, wherein the layer deposition device comprises a build material spreader roller, the method comprising:
with the sensor, detecting a change in a slew torque of the build material spreader roller, the change in the slew torque of the build material spreader roller indicating part drag.

8. The method of claim 6, wherein the layer deposition device comprises a build material warming lamp, the method comprising:
with the sensor, detecting a change in a temperature-related parameter of the build material, the change in the temperature-related parameter of the build material indicating part drag.

9. The method of claim 6, in response to a determination that the sensor detects a change in a process parameter, taking a remedial action to correct the part drag.

10. The method of claim 9, wherein the remedial action comprises, with an ablation laser, removing protrusions from the part along an x,y plane of the build region, tagging the part as a confirmed draggable part, abandoning the build of a layer of the part, abandoning the build of the part, initiating a new build of the part, adjusting a layer thickness of a deposited layer, adjusting a printing parameter of an agent deposited on the build region, adjusting torque output by the build material spreader roller, or combinations thereof.

11. The method of claim 6, wherein detecting a change in a process parameter associated with the operation of the layer deposition device comprises observing violations of an upper control limit (UCL) and a lower control limit (LCL).

12. A non-transitory computer readable medium comprising computer usable program code embodied therewith, the computer usable program code to, when executed by a processor:
activate a layer deposition device at a 3D part build region of a 3D printing device on which a part is built;
detect a change in a process parameter associated with the operation of the layer deposition device, the change in a process parameter indicating part drag; and
taking a remedial action to correct the part drag.

13. The computer readable medium of claim 12, wherein the process parameter comprises a warming parameter of a build material warming lamp, a slew torque of the build material spreader roller, or combinations thereof.

14. The computer readable medium of claim 12, wherein:
the layer deposition device comprises a build material spreader roller;
the computer readable medium comprising computer usable program code to, when executed by the processor:
detect, with a sensor, a change in a slew torque of the build material spreader roller, the change in the slew torque of the build material spreader roller indicating part drag.

15. The computer readable medium of claim 12, wherein:
the layer deposition device comprises a build material warming lamp;
the computer readable medium comprising computer usable program code to, when executed by the processor:
detect a change in a temperature of a build material, the change in the temperature of the build material indicating part drag.
